(19) United States
(12) Patent Application Publication
(10) Pub. No.: US 2013/0341900 A1
(43) Pub. Date: Dec. 26, 2013

(54) METHOD FOR PRODUCING A BACK-LIT COLOUR LASER IMAGE, IDENTITY DOCUMENT USING THIS METHOD AND BACK LIGHTING SYSTEM

(71) Applicants: Jean Pierre Lazzari, Sainte Maxime (FR); Jean Marc Lazzari, Saint Remy l'Honore (FR)

(72) Inventors: Jean Pierre Lazzari, Sainte Maxime (FR); Jean Marc Lazzari, Saint Remy l'Honore (FR)

(21) Appl. No.: 14/004,157

(22) PCT Filed: Mar. 8, 2012
(86) PCT No.: PCT/FR12/00081

§ 371 Date: Sep. 9, 2013

(30) Foreign Application Priority Data
Mar. 10, 2011 (FR) 11/00713

(51) Int. Cl. B42D 15/10

(52) U.S. Cl. CPC B42D 15/10
USPC 283/75; 347/232; 362/98

(57) ABSTRACT

This disclosure includes a system and method for producing a back-lit colour laser image, and an identity document using this method and back lighting system. The body of the identity document may be transparent. In various implementations, the light back-lights the colour laser image which may be formed of sub-pixels partly covered by non-reflective surfaces in the protective layer. The light may enter through tiny holes in decorative patterns on the reverse side of the document. Various implementations may find particular applications for identity cards, credit cards, passports, driving licences, secure entry badges, etc.

### FIELD OF APPLICATION OF THE INVENTION

The subject of the present invention is a method for forming a back-lit colour laser image in an identity document carrying a back-lit colour laser image, and a backlighting system. It finds applications in particular for identity cards, credit cards, passports, driving licences, secure entry badges, etc.

### STATE OF THE PRIOR ART

Colour laser images composed of sub-pixels in the primary additive colours, red, green and blue, abbreviated in the remainder hereof to RGB, require either a device with high reflective yield as described in patent application FR 11/00578 filed on Feb. 28, 2011 or back lighting as used for Liquid Crystal Displays (LCDs). LCD screens are composed of a matrix of RGB pixels behind which there lies a block of liquid crystal cells and finally a back light which illuminates this assembly from behind causing the colour images to appear.

The aforementioned patent application describes the personalisation of a colour laser image formed of sub-pixels (R,G,B) printed underneath a protective layer, the said layer is then hot welded under pressure onto the body of an identity document. This hot welding under pressure of the protective layer is known in the trade as “lamination ”.

A laser beam through the transparent protective sheet via carbonization produces dark, non-reflective surfaces in this transparent protective sheet which partly or wholly mask each sub-pixel (R,G,B) thereby forming the grey levels of a personalised colour laser image of high quality. The transparent protective sheet is commonly called “laserable ” since it is sensitive to laser radiation.

Although of advantage in some respects, these colour laser images, depending on the environment in which they are observed, may require illumination to reinforce the luminosity of the image.

### DISCLOSURE OF THE INVENTION

It is the objective of the present invention to overcome this disadvantage by proposing a method for producing an identity document comprising a personalised colour laser image which is back-lit.

This objective of the invention is achieved by means of a transparent identity document body through which a light flow passes which back lights the personalised colour laser image.

More specifically, the subject of the invention is a method for forming a back-lit personalised colour laser image comprising sub-pixels in the additive primary colours red green and blue. These sub-pixels are protected by a transparent laserable sheet. A laser beam via carbonization above each sub-pixel (R,G,B) causes the grey levels of a personalised colour laser image to appear in the transparent laserable protective sheet. The body of the document is transparent and a light flow passes through it which back lights the personalised colour laser image perpendicular to its plane.

The front side of the identity document comprises a laserable protective sheet which protects the sub-pixels (R,G,B) and the decorative patterns and anti-counterfeit systems. The reverse side carries decorative patterns and an anti-counterfeit system also protected by a transparent sheet laminated on the reverse side of the identity document.

According to a first embodiment of the invention, the light flow enters perpendicular to the plane of the document via the reverse side of the document through an opening made in the decorative patterns and anti-counterfeit systems.

According to one variant of the invention, the reverse side is fully covered by decorative patterns or anti-counterfeit systems. On one surface substantially equal to the surface of the personalised image on the front side of the identity document, and opposite the latter on the reverse side, the decorative patterns and anti-counterfeit system are pierced with tiny holes that are uniformly distributed and allow the passing of a light flow from a source located on the back of the identity document the flow passing through the document perpendicular the plane thereof. This light flow illuminates the personalised colour laser image from behind. The decorative patterns, anti-counterfeit systems and tiny holes are coated with a protective layer laminated on the reverse side of the identity document.

According to another embodiment of the invention, the light enters via least one side of the identity document through its thickness. Diffracting elements located underneath the personalised colour laser image scatter and send the light to behind this image passing through it perpendicular to its plane. Reflective means located on the reverse side of the identity document enhance the intensity of the light sent through the personalised laser image. The identity document is covered with decorative patterns and anti-counterfeit systems on its two sides.

The invention also concerns an identity document comprising a colour laser image back-lit by implementing the above method. This identity document comprises a sheet of laserable material acting as protective layer, this sheet being at least partly carbonized by laser radiation, sub-pixels (R,G,B) printed between the laserable sheet and a transparent document substrate, these sub-pixels (R,G,B) forming an image back-lit by a light flow passing perpendicularly through the image perpendicular to the plane of the document.

According to particular embodiments:
The light enters via the back of the identity document through an opening made in the decorative and anti-counterfeit elements located on the reverse side of the document.
The light enters by the back of the identity document, via uniformly distributed tiny holes through the decorative and anti-counterfeit elements located on the reverse side of the document.
The light enters via at least one side of the body of the identity document through its thickness. The light is diffracted by diffraction elements and passes through the colour laser image in the observer's direction. Reflective means located on the reverse side of the body of the document increase the flow of light.

Finally the invention concerns an edge back lighting system capable of illuminating an identity document as previously described. It comprises a planar base on which the identity document is laid flat, at least one of its sides is placed in contact with at least one light concentrator which captures the light of a light source, and concentrates this light in the thickness of the identity document.

### PRESENTATION OF THE FIGURES

The invention will become better apparent after the following description given for explanatory purposes and in no way limiting. This description refers to the appended drawings in which:

FIG. 1 shows the cross-section of an identity document comprising an RGB colour laser image according to the prior art.

FIG. 2 gives a cross-section of an identity document comprising an RGB colour laser image according to a first embodiment of the invention.

FIG. 3 shows the cross-section of an identity document comprising an RGB colour laser image according to a second embodiment of the invention.

FIG. 4 shows the cross-section of an identity document comprising an RGB colour laser image according to a third embodiment of the invention.

FIG. 5 illustrates a lighting device capable of illuminating an identity document according to the third embodiment of the invention in FIG. 4.

### DETAILED DESCRIPTION:

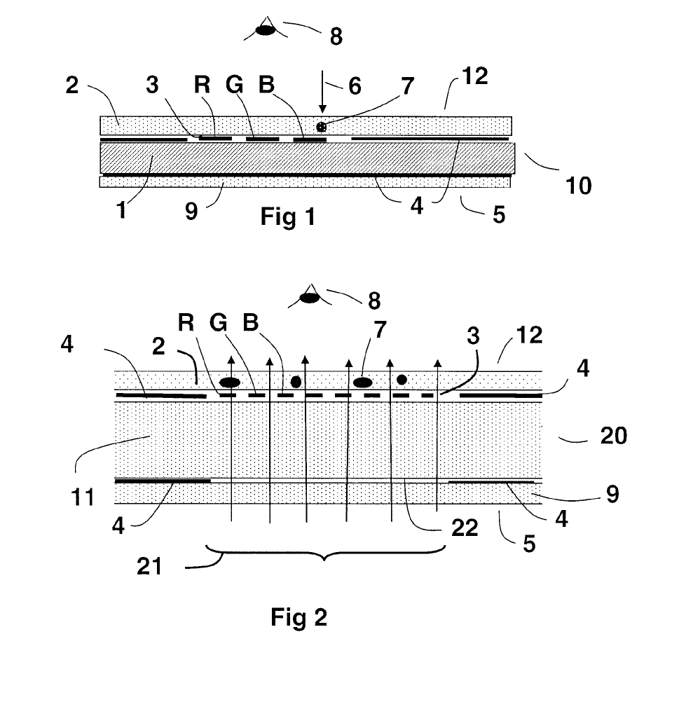

FIG. 1 shows the cross-section (10) of an identity document comprising a colour laser image according to the prior art. It comprises an opaque document body (1), generally white. On its front side (12) a transparent protective laserable sheet (2) is laminated on sub-pixels (R,G,B) (3) and on decorative patterns and anti-counterfeit systems (4). On the reverse side (5) of the identity document there are also decorative patterns and anti-counterfeit systems (4). The whole is protected by a sheet (9) laminated on the reverse side (5) of the identity document.

At a second step a laser beam (6) via carbonization generates the grey levels (7) in the laserable sheet (2) above each sub-pixel (R,G,B), thereby forming the grey levels of a personalised colour laser image. This image is seen by the observer (8) by reflection of ambient light on the personalised colour laser image (3) through the laserable protective sheet (2).

FIG. 2 is a cross-section (20) of an identity document according to a first embodiment of the invention, comprising a back-lit personalised laser image. The body of the document is formed of a transparent sheet (11) which as non-limiting examples can be in polycarbonate, some treated polyvinyl chlorides, treated acrylonitrile-butadiene-styrenes, or treated polyethylene terephthalates. It may be formed of several laminated sheets. Its total thickness is between 50 μm and 1.5 mm. On its front side (12) it comprises the transparent protective sheet (2) which has been laser-treated to form the personalised colour laser image (3). To do so a laser beam via carbonization generates the grey levels (7) above each sub-pixel (R,G,B) located between the transparent protective layer (2) and the transparent body (11) of the identity document, the sub-pixels (R,G,B) and their grey levels (7) forming the personalised colour laser image. All around this personalised colour laser image, on the front side (12) of the identity document, decorative patterns and anti-counterfeit systems (4) have been printed and are also protected by the transparent laserable protective sheet (2).

On the reverse side (5) of the document, decorative patterns and anti-counterfeit systems (4) are printed except on the surface (22) opposite the personalised colour laser image. The elements of the reverse side of the identity document are protected by a transparent protective sheet (9) laminated on this reverse side. A flow of light (21) originating either from an artificial source or from ambient light passes through the back transparent protective sheet (9), the transparent body of the identity document (11) via the opening (22) perpendicular to its plane, and passes from behind through the personalised colour image and the protective sheet (2). The personalised colour laser image via transparency therefore appears to the observer (8) to be efficiently illuminated from behind.

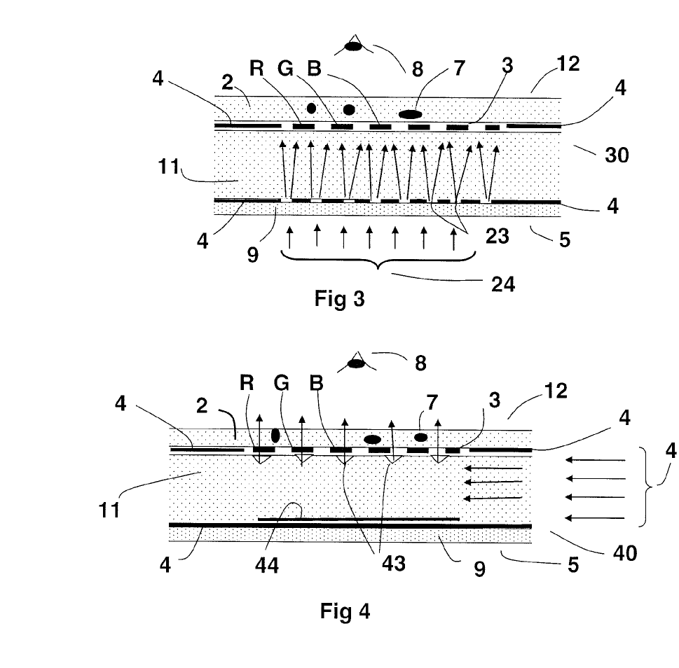

FIG. 3 shows the cross-section (30) of an identity document comprising a back-lit personalised laser image according to a second embodiment of the invention. On the front side (12) of the identity document it comprises the same elements as those described previously, in particular the personalised colour laser image composed of sub-pixels (R,G,B), of the laserable sheet (4) of grey levels (7). It also comprises the decorative and anti-counterfeit elements (4). The reverse side (5) of the identity document carries decorative patterns and anti-counterfeit elements over its entire surface. For back lighting of the personalised colour laser image (3), the light flow enters via the reverse side (5) of the document through tiny holes (23) uniformly distributed and made through the decorative patterns and anti-counterfeit elements, behind the personalised colour laser image so as to allow passing of the light, derived from the source (24), perpendicular to the plane of the document. These tiny holes do not deteriorate the quality of the decorative patterns or anti-counterfeit systems since they are hardly visible. They have a diameter of between 5 μm and 500 μm. This light, passing through these holes, illuminates the personalised colour laser image from behind. It is seen by the observer (8) via transparency with strong luminosity. All the elements of the reverse side (5) of the identity document are protected by a transparent protective sheet (9) laminated on the reverse side of the identity document.

FIG. 4 shows the cross-section (40) of an identity document comprising a back-lit personalised laser image according to a third embodiment of the invention. The front side (12) of the identity document comprises the same elements as those in the preceding Figures, in particular the personalised colour laser image (3) composed of the sub-pixels (R,G,B), of the laserable sheet (2)of grey levels (7). It also comprises the decorative and anti-counterfeit elements (4). On at least one of the sides of the identity document a flow of light (41) created by an artificial source enters into the body of the transparent identity document (11) through its thickness.

On the front side (12) of the body (11) of the identity document there are elements (43) diffracting the light circulating in the thickness of the body of the document(11), and sending it back perpendicularly in the direction of the observer (8) through the personalised colour laser image (3). These diffracting elements (43), known to persons skilled in the art for LCD screens in particular, can be micro-cavities for example formed on the surface of the body (11) of the identity document. To reinforce the intensity of the diffracted light, reflective means (44) are located on the reverse side of the body of the document. These means may be a reflective varnish or a reflective metal foil. These means are covered by the decorative and anti-counterfeit elements (4), the whole being protected by the protective sheet (9) laminated on the reverse side (5) of the identity document.

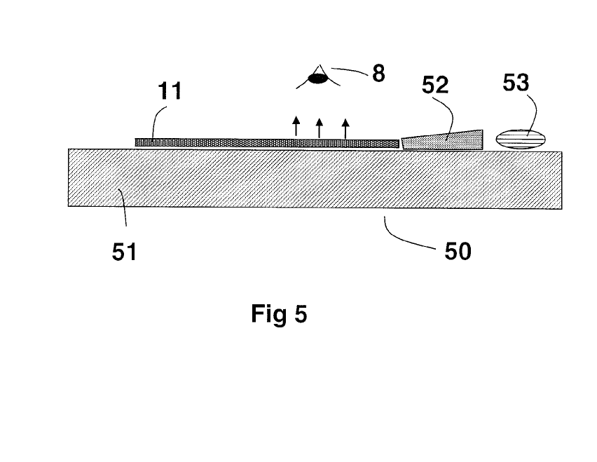

FIG. 5 shows a cross-section (50) of a back lighting system capable of illuminating an identity document as illustrated in FIG. 4. It comprises a planar base (51) on which the identity document (11) is laid flat, characterized in that at least one of its sides is placed in contact with at least one light concentrator which captures the light of a light source and concentrates this light in the thickness of the identity document. The light generating means may advantageously be light emitting diodes (53). They are optically connected to the light concentrator (52) which focuses the flow of light in the thickness of the body (11) of the identity document. The light back-lights the personalised colour laser image which is clearly seen by the observer (8).

1. A method for producing, on a document, a back-lit personalised colour laser image comprising sub-pixels in the additive primary colours red green blue, protected by a transparent laserable sheet, the method comprising:
carbonizing, via a laser beam, the transparent laserable protective sheet above each sub-pixel causing grey levels to appear of a personalised colour laser image,
wherein the document is transparent such that a light flow passes through, which back lights the personalised colour laser image perpendicular to the plane of the document.

2. The method for producing a back-lit personalised colour laser image according to claim 1, wherein the light flow enters perpendicular to the plane of the document via the reverse side of the document through an opening made in decorative patterns and anti-counterfeit systems.

3. The method for producing a back-lit personalised colour laser image according to claim 1, wherein the light flow originates from a source behind the document and enters via the reverse side of the document through uniformly distributed tiny holes made through decorative and anti-counterfeit elements, and illuminates the personalised colour laser image from behind perpendicular to the plane of the document.

4. The method for producing a back-lit personalised colour laser image according to claim 1 wherein the document is an identity document, and wherein the light flow enters via at least one side of the identity document through its thickness, the light flow being diffracted by diffracting elements located underneath the personalised colour laser image which scatter and send the light to behind the personalised laser image perpendicular to the plane of the personalised laser image, and
wherein reflective means located on the reverse side of the identity document enhance the intensity of the light sent back through the sub-pixels.

5. An identity document comprising a colour laser image back-lit by implementing the method according to claim 1, wherein the identity document comprises
a sheet of laserable material, acting as a protective layer, which is at least partly carbonized by laser radiation, of the sub-pixels printed between the laserable sheet and a transparent document substrate, these sub-pixels forming a colour laser image back-lit by a light flow passing through the colour laser image perpendicular to the plane of the identity document.

6. The identity document according to claim 5 wherein the light enters via the back of the identity document through an opening made in decorative or anti-counterfeit elements located on the reverse side of the identity document.

7. The identity document according to claim 5 wherein the light enters via the back of the identity document through uniformly distributed tiny holes made through decorative or anti-counterfeit elements located on the reverse side of the identity document.

8. The identity document according to claim 5 wherein the light enters via at least one side of the identity document, in the thickness thereof, and is diffracted by diffracting elements so that the light passes through the colour laser image in the direction of the observer, and wherein reflective means located on the reverse side of the document increase light flow.

9. An edge back lighting system capable of illuminating an identity document according to claim 8, comprising
a planar base on which the identity document is laid flat, wherein at least one of the sides of the planar base is placed in contact with at least one light concentrator which captures the light of a light source and concentrates the light onto the identity document.
